(19) United States
(12) Patent Application Publication
(10) Pub. No.: US 2012/0258730 A1
(43) Pub. Date: Oct. 11, 2012

(54) ESTIMATING ACCESS TERMINAL LOCATION BASED ON BEACON SIGNALS FROM FEMTO CELLS

(75) Inventors: Peerapol TINNAKORNSRISUPHAP, San Diego, CA (US); Varun KHAITAN, San Diego, CA (US); Mehmet YAVUZ, San Diego, CA (US)

(73) Assignee: QUALCOMM Incorporated, San Diego, CA (US)

(21) Appl. No.: 13/305,553

(22) Filed: Nov. 28, 2011

Related U.S. Application Data
(60) Provisional application No. 61/417,756, filed on Nov. 29, 2010.
(60) Provisional application No. 61/472,523, filed on Apr. 6, 2011.

(51) Int. Cl. H04W 4/02

(52) U.S. Cl. 455/456.1

(57) ABSTRACT

A location of an access terminal is estimated based on signals received by the access terminal. The manner in which a femto cell transmits signals and/or the manner in which the access terminal monitors for signals may be controlled in some cases to facilitate the reception of signals at the access terminal during a location determination operation. In some embodiments, the number of femto cells for which the access terminal monitors for signals may be controlled by controlling the manner in which the access terminal maintains its active set. In some embodiments, in the event a given femto cell is interfering with the ability of an access terminal to receive signals from other femto cells, that femto cell may be instructed to temporarily stop transmissions (e.g., on the traffic channel and/or a beacon channel).

### CLAIM OF PRIORITY

This application claims the benefit of and priority to commonly owned U.S. Provisional Patent Application No. 61/417,756, filed Nov. 29, 2010, and assigned Attorney Docket No. 110371P1, and U.S. Provisional Patent Application No. 61/472,523, filed Apr. 6, 2011, and assigned Attorney Docket No. 110371P2, the disclosure of each of which is hereby incorporated by reference herein.

### Cross-Reference to Related Application

This application is related to concurrently filed and commonly owned U.S. Patent Application No. ______, entitled “CONTROL SCHEMES FOR DETERMINING ACCESS TERMINAL LOCATION,” and assigned Attorney Docket No. 110371U2, the disclosure of which is hereby incorporated by reference herein.

### BACKGROUND

1. Field

This application relates generally to wireless communication and more specifically, but not exclusively, to determining a location of an access terminal.

2. Introduction

A wireless communication network may be deployed over a defined geographical area to provide various types of services (e.g., voice, data, multimedia services, etc.) to users within that geographical area. In a typical implementation, access points (e.g., each supporting one or more macro cells) are distributed throughout a macro network to provide wireless connectivity for access terminals (e.g., cell phones) that are operating within the geographical area served by the network.

Access terminal-related applications may make use of the location of the access terminal. For example, the location of an access terminal may be reported during a 911 call by the access terminal. As another example, an access terminal-based navigation system uses the current location of the access terminal for providing navigational aids.

Various techniques have been used to estimate the location of an access terminal. In some implementations, an access terminal is configured to calculate location based on signals received from nearby macro cells. In some implementations, an access terminal includes a Global Positioning System (GPS) receiver that receives signals from GPS satellites to determine the current location of the access terminal. In some implementations, an access terminal includes a Wi-Fi transceiver that calculates location based on signals received from nearby Wi-Fi base stations.

These techniques may estimate a location based on analysis of received signal strength or received signal timing. Several examples these schemes follow. Signal Strength Triangulation and Fingerprinting is a method where the location of an access terminal is estimated by obtaining a set of signal strength measurements from a group of transmitters and matching this set, known as a fingerprint, against a database of measurements from a grid of points in the coverage area. Advanced Forward Link Trilateration (AFLT) is a location technology that relies on a time difference of arrival from multiple base stations at the access terminal. Observed Time Difference Of Arrival (OTDOA) is a standardized location estimation method for UMTS where the observed time difference of pilots between a pair of base station signals at the access terminal is used to calculate an estimate of the location (as a hyperboloid) and optionally, the velocity of the access terminal. Uplink Time Difference of Arrival (UTDOA) is also a standardized location estimation method for UMTS where the observed time difference is calculated between the access terminal and a pair of Location Measurement Units (LMUs). The observed time difference is calculated by maximizing the correlation of time-shifted received signals at the LMUs.

In practice, conventional location estimation technologies such as GPS and macro cell tower based location estimation may not be very effective indoors due to poor signal quality or limited accuracy in location estimation. For example, satellite-based location estimation systems such as GPS may perform poorly indoors as the signals from the satellites may be too weak to be decoded. Traditional terrestrial-based location estimation techniques used in macro cellular environments also may not yield satisfactory accuracy required for indoor applications.

Moreover, some conventional location technologies require that the access terminal include specialized hardware. For example, a GPS-based scheme requires that the access terminal include a GPS receiver. Similarly, a Wi-Fi-based scheme requires that the access terminal include a Wi-Fi transceiver. Consequently, these techniques cannot be used on legacy access terminals that do not include the necessary hardware.

In view of the above, there is a need for improved techniques for estimating the location of an access terminal (e.g., in an indoor environment).

### SUMMARY

A summary of several sample aspects of the disclosure follows. This summary is provided for the convenience of the reader and does not wholly define the breadth of the disclosure. For convenience, the term some aspects may be used herein to refer to a single aspect or multiple aspects of the disclosure.

The disclosure relates in some aspects to estimating a location (position) of an access terminal based on signals measured by an access terminal. The location of the access terminal (and, hence, the position of a user of the access terminal) may be determined with respect to a group of femto cells using one of the techniques that follow or a combination of these techniques. An access terminal may measure the received strength of a forward link pilot from a group of femto cells. An access terminal may measure the received strength of beacon signals transmitted by a group of femto cells on non-traffic channels (e.g., macro frequencies that are not used by the femto cells for serving access terminals). An access terminal may measure the timing (e.g., time difference of arrival) of signals received from a group of femto cells.

In these methods, a so-called “fingerprint” based on the current set of measured information (e.g., Ecp/Io or signal transmission delay measured for each femto cell) is obtained and matched against different sets of previously defined fingerprints associated with different locations within a given environment (e.g., within the coverage of a set of femto cells). By comparing the current fingerprint with the previously defined fingerprint information, a location that is most likely associated with the current fingerprint may be identified. This location is then indicated as corresponding to the current location of the access terminal. For example, in implementations where path loss values are derived from measured pilot strength (e.g., Ecp) and interference (e.g., Io) information, the fingerprint maps different locations to different sets of path loss values that are associated with different sets of femto cells (e.g., location M corresponds to path losses A, B, and C from an access terminal to femto cells X, Y, and Z, respectively). In implementations that use transmission delay information, the fingerprint maps different locations to different sets of time delay values that are associated with different sets of femto cells (e.g., location M corresponds to signal propagation time delays A, B, and C from femto cells X, Y, and Z, respectively, to an access terminal).

In some implementations, the defined fingerprint information is implemented as a database or prediction model. Values for the database or prediction model may be generated, for example, by ray tracing models that use knowledge of the physical environment around the femto cells and the building materials. Here, for each designated location within the physical environment, a set of values of received signal strengths (or corresponding path losses) or propagation times from all femto cells “seen” at that location is created. Thus, each defined location within the environment is associated with a set of values (e.g., path loss or timing values) corresponding to the values (or a range of values) that are expected at that location. These values are then stored in the database in association with the corresponding defined location.

The manner in which a femto cell transmits signals and/or the manner in which the access terminal monitors for signals may be controlled in some cases to facilitate the reception of signals at the access terminal during a location determination operation.

For example, femto cells may be instructed to transmit beacon signals at certain times and/or on certain frequencies (e.g., to avoid interference between beacon signal transmissions by different femto cells). In addition, the access terminal may be instructed to monitor for beacon signals at those times and/or on those frequencies. In this case, the amount of interference caused by beacon signal transmissions may be reduced since different femto cells may transmit beacon signals at different times and/or on different frequencies. In some embodiments, a beacon signal comprises a pilot signal transmitted on a different channel from an operating channel of a femto cell.

In addition, upon commencing a location determination procedure for an access terminal, the femto cells may be instructed to commence beacon signal transmissions and the access terminal may be instructed to monitor for beacon signals. The monitoring may be done at particular time instance based on at least one instruction from the femto cells. In this case, the amount of interference caused by beacon signal transmissions may be reduced since beacon signals may be turned off (or transmitted less frequently) when the location determination procedure is not being performed.

As another example, during a location determination operation for an access terminal in a particular area (e.g., where the general area is indicated by the femto cell that is serving the access terminal), a limited set of femto cells may be instructed to transmit beacon signals. In addition, the access terminal may be instructed to monitor for beacons signals only from these femto cells. In this case, the amount of interference caused by beacon signal transmissions may be reduced since not all of the femto cells of a set of femto cells will be transmitting beacon signals. Moreover, the location estimation procedure may be performed quicker since the access terminal is measuring beacon signals from a reduced set of femto cells.

In conjunction with the above operations and other operations as taught herein, one or more components of a communication system may be configured to support various communication schemes. In some aspects, a communication scheme comprises: determining beacon signal transmission timing for a plurality of femto cells for access terminal location estimation; and sending at least one message to control transmission of beacons signals at the plurality of femto cells as a result of the determination. In some aspects, a communication scheme comprises: receiving a message requesting transmission of beacons signals, wherein the message indicates beacon signal transmission timing for access terminal location estimation; and transmitting beacon signals in a manner based on the received message. In some aspects, a communication scheme comprises: determining beacon signal transmission timing for a plurality of femto cells for access terminal location estimation; and sending a message to control beacon signal monitoring at an access terminal as a result of the determination. In some aspects, a communication scheme comprises: receiving a message requesting monitoring of beacons signals, wherein the message indicates beacon signal transmission timing for access terminal location estimation; and monitoring beacon signals in a manner based on the received message.

In some embodiments, the number of femto cells for which the access terminal monitors for signals may be controlled by controlling the manner in which the access terminal maintains its active set. For example, threshold parameters (e.g., T_ADD and T_DROP) that control how the access terminal determines whether to add or drop a femto cell to/from the active set may be reduced during a location determination operation. Thus, femto cells will be more readily added to the active set and less readily dropped from the active set. Accordingly, in some aspects, a communication scheme comprises: determining that at least one location of an access terminal is to be estimated; and sending a message to adjust an active set parameter for the access terminal as a result of the determination.

In some embodiments, in the event a given femto cell is interfering with the ability of an access terminal to receive signals from other femto cells, that femto cell may be instructed to temporarily stop transmissions (e.g., on the traffic channel and/or a beacon channel). The access terminal may then be instructed to monitor for transmissions from other femto cells during this time. Accordingly, in some aspects, a communication scheme comprises: determining that at least one location of an access terminal is to be estimated; identifying a first femto cell that interferes with reception of signals at the access terminal; sending a message to temporarily limit transmissions by the first femto cell; and sending a message instructing the access terminal to monitor for signals while the transmissions by the first femto cell are limited.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of several sample aspects of a communication system adapted to estimate a location of an access terminal;

FIG. 2 is a flowchart of several sample aspects of operations that may be performed in conjunction with controlling the transmission of beacon signals for access terminal location estimation;

FIG. 3 is a flowchart of several sample aspects of operations that may be performed in conjunction with controlling monitoring for beacon signals for access terminal location estimation;

FIG. 4 is a flowchart of several sample aspects of operations that may be performed to select which femto cells transmit beacon signals for access terminal location estimation;

FIG. 5 is a flowchart of several sample aspects of operations that may be performed to adjust at least one active set parameter in conjunction with access terminal location estimation;

FIG. 6 is a flowchart of several sample aspects of operations that may be performed to limit transmissions by a femto cell in conjunction with access terminal location estimation;

FIG. 7 is a simplified block diagram of several sample aspects of components that may be employed in communication nodes;

FIG. 8 is a simplified diagram of a wireless communication system;

FIG. 9 is a simplified diagram of a wireless communication system including femto nodes;

FIG. 10 is a simplified diagram illustrating coverage areas for wireless communication;

FIG. 11 is a simplified block diagram of several sample aspects of communication components; and

FIGS. 12-16 are simplified block diagrams of several sample aspects of apparatuses configured to support access terminal location estimation as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

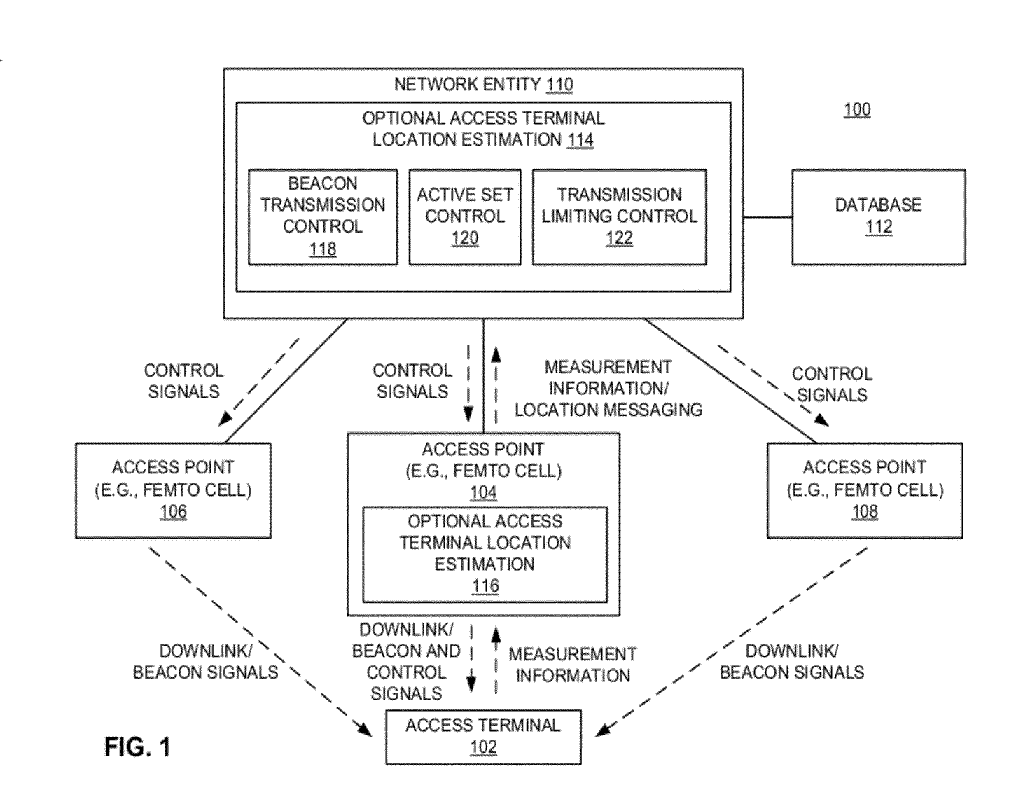

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, femto cells, Home NodeBs, Home eNodeBs, and so on, while access terminals may be referred to or implemented as user equipment (UEs), mobile stations, mobile devices, and so on.

Access points in the system 100 provide access to one or more services (e.g., network connectivity) for one or more wireless terminals (e.g., an access terminal 102) that may be installed within or that may roam throughout a coverage area of the system 100. For example, at various points in time the access terminal 102 may connect to an access point 104, an access point 106, an access point 108, or some access point in the system 100 (not shown). Each of these access points may communicate with one or more network entities (represented, for convenience, by a network entity 110) to facilitate wide area network connectivity.

The network entity 110 may take various forms such as, for example, one or more radio and/or core network entities. Thus, in various implementations the network entity 110 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals. Also, two or more network entities may be co-located and/or two or more network entities may be distributed throughout a network.

In a typical implementation, the access points 104-108 comprise low-power access points (e.g., having a transmit power of 25 milliwatts or less). These low-power access points are typically deployed to supplement conventional network access points (e.g., macro access points) by providing more robust indoor wireless coverage or other coverage to access terminals. Such low-power access points may be referred to as, for example, femto access points, femto cells, home NodeBs, home eNodeBs, or access point base stations. Typically, such low-power access points are connected to the Internet and the mobile operator's network via a DSL router or a cable modem. For convenience, low-power access points may be referred to as femto cells or femto access points in the discussion that follows.

A femto cell may be deployed in the same frequency channel with the macro cell (co-channel deployment) or in a separate channel that is not in use by the macro cell (dedicated channel deployment). When an access terminal comes in close proximity of a femto cell, it detects the femto cell pilot and makes a handoff from the macro cell. An access terminal that is operating on the same channel with the femto cell detects the pilot through a neighbor list pilot search. For access terminals on the macro-only channels, handoff is enabled through transmission of beacon signals (e.g., pilot beacons). Alternatively, the access terminal may autonomously perform inter-frequency scans due to weak macro cell pilot or proximity to the femto cell. Thus, in conjunction with standard mobility operations, an access terminal is able to acquire downlink signals (e.g., pilots, data, etc.) and beacon signals from nearby femto cells.

The disclosure relates in some aspects to using a network of femto cells (e.g., a group or cluster of femto cells that are controlled by a common entity) for access terminal location operations. Advantageously, as the coverage of each femto cell is relatively small, a finer resolution may be achieved via location techniques based on triangulation of information (e.g., path loss and timing) derived from signals received from femto cells. Moreover, the use of femto cells can facilitate locating legacy 3G access terminals without modification and without requiring support from any additional radio technology (e.g., GPS or Wi-Fi).

To this end, one or more of the entities of FIG. 1 include access terminal location estimation functionality and have access to a database 112 that stores fingerprint-related information. The database 112 may be located locally (e.g., located in the network entity 110 or the access point 104) or at a remote location in the network. Also, in some cases, the database 112 may be distributed whereby copies of the database information are stored at different entities in the network (e.g., stored in the network entity 110 and in the access point 104).

For purposes of illustration, the network entity 110 and the access point 104 are depicted as optionally including functionality for access terminal location estimation 114 and 116, respectively. It should be appreciated that other entities (e.g., other access points and access terminals) may include such functionality. For example, a network entity, a femto cell, an access terminal, or some other entity may control location estimation operations. Thus, for location estimation, such an entity may control downlink or beacon signal transmissions by the femto cells and associated monitoring at an access terminal. Moreover, such an entity may acquire downlink or beacon measurement information and use this information to estimate a location of the access terminal.

In some implementations, different steps of the location estimation procedure may be performed by different entities. For example, an application on an access terminal may initiate a location estimation procedure. The serving access point or some other network entity may then control the operation of the access points and access terminal to acquire the downlink or beacon information. In addition, one of these entities or some other entity may use the acquired information and information obtained from a local or network fingerprint database to estimate the location of the access terminal. Several typical examples follow.

In some implementations, the network entity 110 (e.g., a femto management server, a femto convergence server, or some other suitable entity) manages location estimation procedures. In this case, the network entity 110 may send control signals to the access points 104-108 to control downlink transmission and/or beacon signal transmission for a location estimation procedure. In addition, the network entity 110 may send control signals to the access point 104 (e.g., the current serving femto cell for the access terminal 102) to control monitoring at the access terminal 102 or request measurement information from the access terminal 102. Based on these control signals, the access point 104 may send control signals to the access terminal 102 (e.g., requesting a measurement report). Upon completing a measurement operation, the access terminal 102 sends measurement information to the access point 104 which then forwards the information to the network entity 110. The network entity uses the measurement information to estimate a location of the access terminal 102.

In some implementations, the access point 104 (e.g., the current serving femto cell for the access terminal 102) manages location estimation procedures. In this case, the access point 104 may send control signals to the access points 106 and 108 to control downlink transmission and/or beacon signal transmission for a location estimation procedure. In some embodiments, the access point 104 sends control signals to the access points 106 and 108 via the network entity. In some embodiments, femto cells send control signals directly to each other (e.g., via interfaces such as Iur-h (for HNB) or X2 (for HeNB)). The access point 104 also controls its own downlink transmission and/or beacon signal transmission for the location estimation procedure. In addition, the access point 104 may send control signals (e.g., requesting a measurement report) to the access terminal 102 to control monitoring at the access terminal 102 or request measurement information from the access terminal 102. Upon completing a measurement operation, the access terminal 102 sends measurement information to the access point 104. The access point 104 uses the measurement information to estimate a location of the access terminal 102.

In general, the accuracy of the access terminal location estimation improves with the number of visible signal sources (e.g., femto cells). Consequently, it is desirable for an access terminal to be able to measure signals from a large number of femto cells. In practice, however, an access terminal may detect a signal (e.g., a pilot) from a femto cell only if the signal to interference-plus-noise ratio for the signal (e.g., SINR or Ecp/Io) is above a detection threshold (e.g., on the order of −20 dB).

Nearby femto cells and macro cells (if the femto cell operates on a channel that is shared or adjacent to a macro cell channel) may interfere with the measurements made by an access terminal. This interference, in turn, may adversely affect the accuracy of the triangulation operations. For example, when an access terminal is close to its serving femto cell, the interference generated by the serving cell when the access terminal is measuring non-serving cells is relatively high. In a case where the access terminal cannot measure any other femto cells, the triangulation set may degenerate to a single cell (i.e., the serving cell). In other words, the location of the serving femto cell may simply be indicated as the predicted location for the access terminal (which may not be accurate). Thus, although the call quality is the best when the access terminal is very close to a femto cell, this situation may prevent the access terminal from detecting signals (e.g., pilots) from other femto cells.

Several techniques that may be employed to more effectively estimate the location of an access terminal are represented by the beacon transmission control 118, active set control 120, and transmission limiting control 122 components of the access terminal location estimation 114 of FIG. 1. In some aspects, these techniques relate to increasing the number of signal sources that may be acquired by an access terminal. Thus, these techniques may provide, for example, effective location estimation even when the access terminal is very close a femto cell.

For purposes of illustration, only the access terminal location estimation 114 is depicted as comprising the beacon transmission control 118, the active set control 120, and the transmission limiting control 122. It should be appreciated that other entities in a communication system (e.g., the access terminal location estimation 116) may include such functionality.

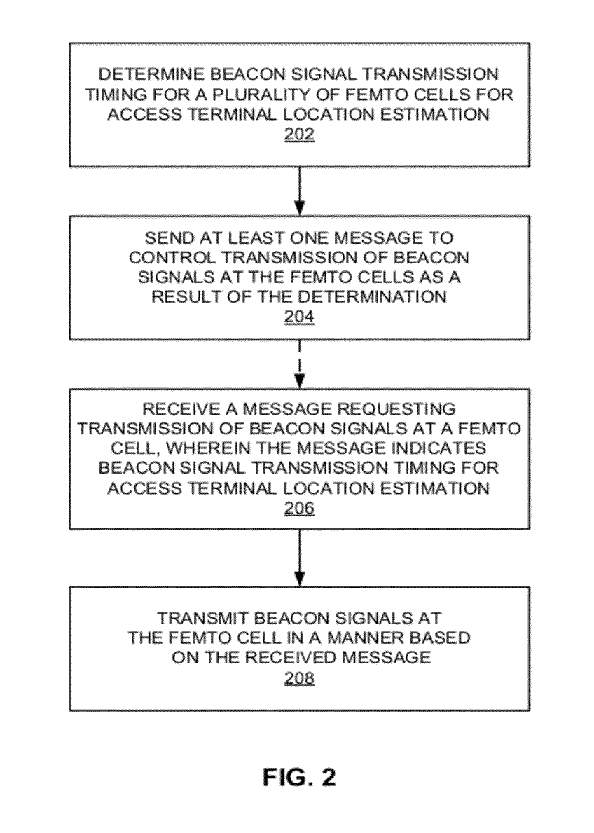

The beacon transmission control 118 provides functionality to facilitate estimating access terminal location based on beacon signals transmitted by a plurality of femto cells. Here, since beacon signals may be transmitted on frequencies that are different from the forward link frequency used by the serving cell for the access terminal, the access terminal is able to receive these signals even when there is significant interference on the forward link for location estimation (e.g., due to the access terminal being very close to its serving femto cell). Moreover, the manner in which beacon signals are transmitted and monitored may be controlled to facilitate more efficient location estimation. For example, since beacon signals need not be transmitted continuously, time division techniques may be employed so that different femto cells will transmit their respective beacon signals at different times. Examples of these and other beacon-related operations are described in more detail below in conjunction with FIGS. 2-4.

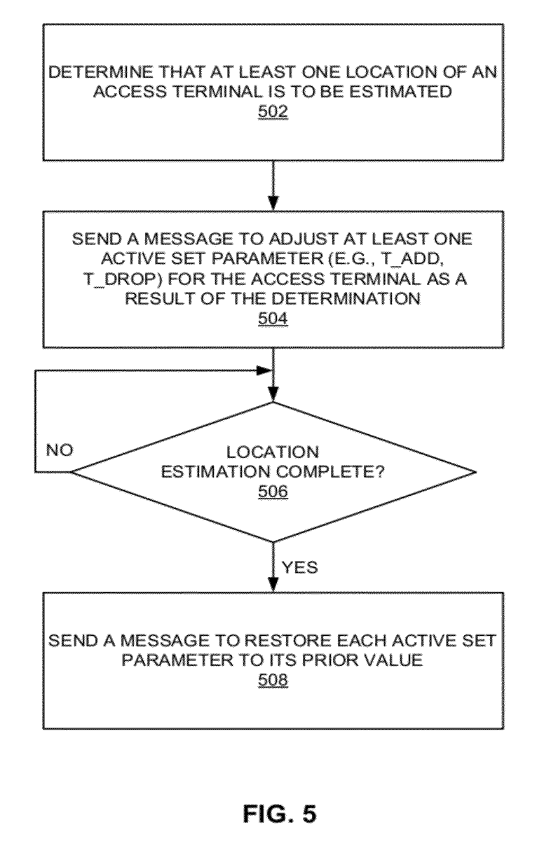

The active set control 120 provides functionality to facilitate adding additional femto cells to the active set of an access terminal for location estimation. For example, at least one parameter (e.g., T_ADD and/or T-DROP) may be adjusted during a location estimation procedure for an access terminal in an attempt to cause the access terminal to include more femto cells in its active set. In this way, the access terminal may be able to measure signals from additional femto cells and thereby improve the accuracy of the location estimation. Examples of these operations are described in more detail below in conjunction with FIG. 5.

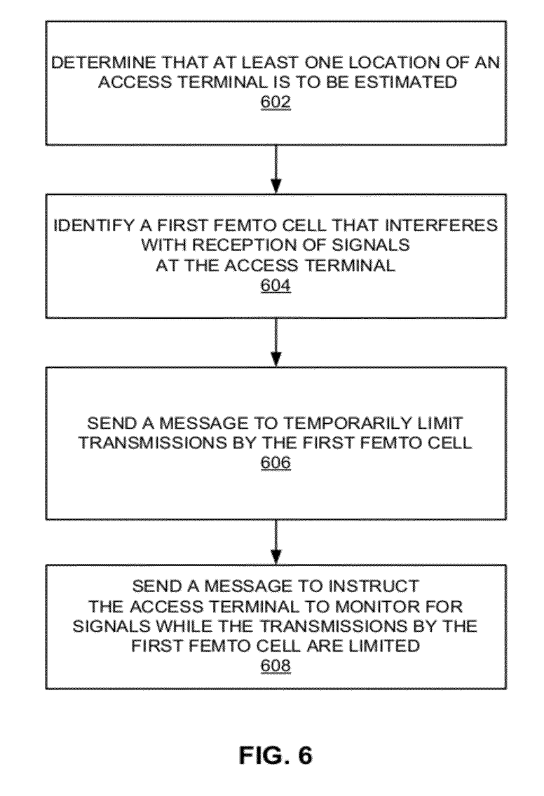

The transmission limiting control 122 provides functionality to temporarily limit interfering transmissions by a femto cell during a location estimation procedure for an access terminal. The access terminal may then be instructed to monitor for signals from other femto cells while the transmissions of the interfering femto cell are limited. In this way, the access terminal may be able to measure signals from these other femto cells even when the access terminal is very close to another femto cell. Examples of these operations are described in more detail below in conjunction with FIG. 6.

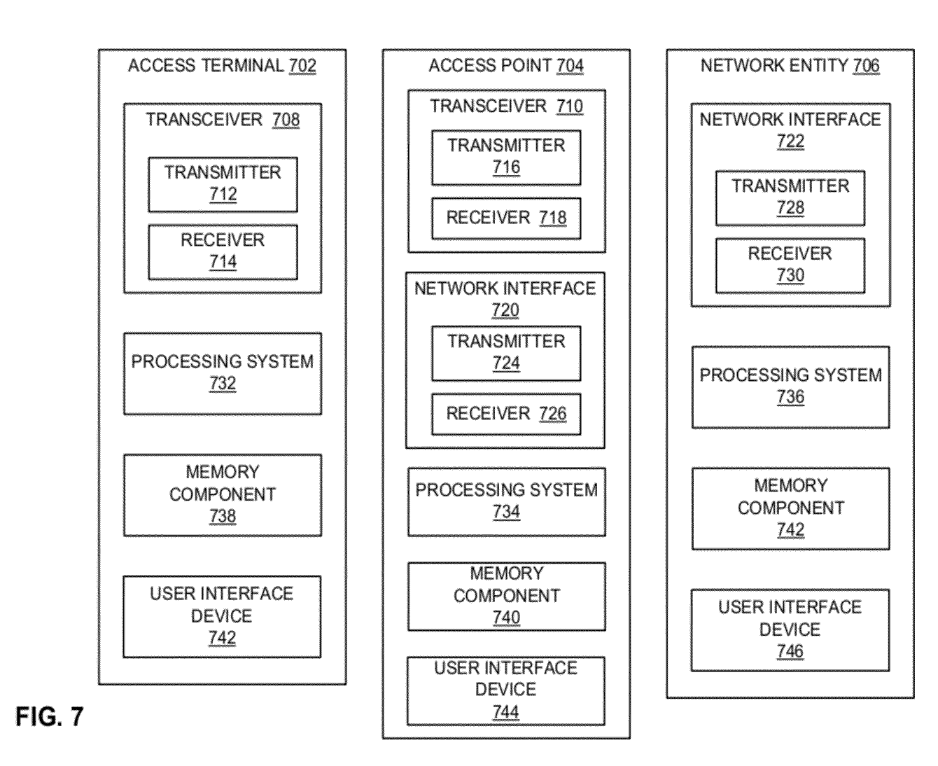

For convenience, the operations of the flowcharts of FIGS. 2-6 (or any other operations discussed or taught herein) may be described as being performed by specific components (e.g., the components of FIG. 1 or FIG. 7). It should be appreciated, however, that these operations may be performed by other types of components and may be performed using a different number of components. It also should be appreciated that one or more of the operations described herein may not be employed in a given implementation.

As mentioned above, FIGS. 2-4 relate to controlling the transmission of beacon signals in conjunction with an access terminal location estimation procedure. Prior to discussing the operations of FIGS. 2-4, several examples of interference mitigation techniques that may be employed in conjunction with these operations will be discussed.

As used herein a beacon signal of a femto cell is communication network signal comprising a known sequence (e.g., a pilot signal) that is transmitted on a frequency other than the frequency of the current forward link of the femto cell. Typically, a beacon signal is transmitted on an intermittent (e.g., periodic) basis. In some implementations, a beacon signal is implemented as a channel (e.g., BCCH in GSM, BCH[PCCPCH] in UMTS, and broadcast control channel and pilot channel in CDMA). Only two beacon signals from other femto cells are needed for successful triangulation. This is because the access terminal will readily have a measurement of its serving femto cell on the femto cell downlink (i.e., the forward link traffic channel).

In practice, different femto cells could concurrently transmit beacon signals on the same frequency. This could diminish the ability of an access terminal to measure the beacons signals from one or more of these femto cells. Accordingly, to mitigate this potential beacon interference, different femto cells may be instructed as to how they are to transmit beacon signals.

Specifically, one or more of the following may be controlled to improve the efficiency of the location estimation operation: 1) the times at which a given femto cell transmits a beacon signal; 2) the frequency on which a given femto cell transmits a beacon signal; or 3) a function used by a femto cell to transmit a beacon signal; or 4) the specific femto cells that transmit beacon signals. Thus, in conjunction with a location estimation procedure, the femto cells may be controlled to transmit beacon signals according to one or more of the above parameters. In addition, the access terminal may be controlled to monitor for beacon signals according to the specified parameter(s).

If the femto cells transmit their respective beacon signals on different frequency channels in a time division multiplexed manner, as measurements are made by the access terminal on the channels at multiple instances, the access terminal will detect signals from different femto cells as the other femto cell interferers are removed. Consequently, the path loss to a larger number of femto cells can be determined (e.g., based on beacon signal strength measurements) and effectively used as a fingerprint to determine the location of the access terminal.

The number of visible beacons could be maximized if the beacon signals were be transmitted on a clean channel (e.g., no macro cell transmission) for location estimation purposes. In practice, however, the beacon signals may need to be transmitted on the macro channel. As a result, there may be additional interference due to the macro cell signals.

Several examples of beacon control schemes are set forth below. For purposes of illustration, these schemes are referred to as staggered beacons, coordinated beacons, and beacon amplitude formula.

In a staggered beacon scheme, the beacon signal transmissions by all the femto cells follow a schedule. As a result, the femto cells do not interfere with each other and, through multiple measurements; the access terminal is able to estimate its path loss to a large number of femto cells. The scheduling of beacons can also be done on a real time basis wherein the serving femto cell turns off its beacon and simultaneously requests the access terminal for a candidate frequency search (CFS) report. This special CFS report is very likely to contain measurements of multiple non-serving femto cells and thus addresses the inter-femto interference problem.

In a coordinated beacon scheme, the transmission of beacon signals will be coordinated, so that a maximum number of beacon measurements are obtained in minimum time. Depending on the access terminal's current location, as reflected by the CFS report, some femto cells, that are acting as strong interferers to other cells will be asked to turn off their beacons while other femto cells will be asked to increase their beacon signal power. This cooperation will be facilitated by the serving femto cell or, in the alternative, by a central network entity.

In one example embodiment, there are five femto cells: A, B, C, D, and E, and the access terminal is currently being served by femto cell A. In its CFS report, the access terminal reports A and B but not the others, as their Ecp/Io values are low. If A turns off its beacon and requests another measurement, then B and C are reported. Next, if femto cell B is asked to turn off its beacon and D and E are asked to increase their powers, then D and E will be reported in the next instance. In one embodiment, this process will be repeated so that measurements from all femto cells can be updated periodically.

The coordination among femto cells can be orchestrated on a per-report basis or a transmit pattern can be specified to each femto cell, which changes over time as the access terminal moves. This dynamic scheduling of transmission may provide high location estimation accuracy. If the beacon signals are being transmitted on the macro channel, the impact to macro users will be minimized by transmitting beacon signals for a very small duration. The access terminal will be then asked to make measurements at the precise transmission instant by specifying it, for example, in the ‘action time’ field of the CFS request message.

If beacon signals are transmitted one at a time (i.e., the beacon signal measurements are spaced in time), location estimation inaccuracies may be introduced if the access terminal is moving since successive measurements will correspond to different locations in this case. Consequently, to improve performance, non-interfering beacons may be grouped to transmit together in order to minimize the time required for triangulation. In other words, the femto cells that transmit these beacons may be instructed to transmit the beacons at approximately the same time. In this way, the total time duration within which a complete set of measurements is obtained may be made as small as possible. In some embodiments, to achieve quick measurements, the femto cell will send back-to-back requests to the access terminal to perform CFS, while scheduling beacon signal transmissions appropriately. Another alternate approach involves scheduling beacon signal transmissions on multiple frequencies (e.g., by sending corresponding instructions to the femto cells) and asking the access terminal to make measurements one after the other and report them at once. If the access terminal has a wideband receiver, it could potentially measure all channels at the same time.

In a beacon amplitude formula scheme, beacon signal interference avoidance may be achieved by using different amplitude formulas at different femto cells to transmit beacon signals. The amplitude formulas relate, in some aspects, to determining different amplitudes at different times for beacon transmission. For example, the amplitude of the beacon signal transmission may be altered based on a periodic signal, such as a sinusoid. The serving femto cell requests the access terminal for multiple CFS reports and aligns the requests with its own transmission. Reports requested at the peak of the sinusoid will contain the strength of the serving femto and the other femto cells are likely to be drowned below the detection threshold. On the other hand, requests at the lowest points of the sinusoid will have measurements of the non serving femto cells and when combined, both these reports can help accurately locate the access terminal.

As a specific example, one femto cell may be configured to adjust its beacon signal based on a certain phase of a sinusoid while another femto cell may be configured to adjust its beacon signal based on a different phase (e.g., 180 degrees out of phase). Consequently, the amplitude of one beacon signal will be at its maximum while the amplitude of the other beacon signal will be at its minimum, and vice versa. Hence, an access terminal may acquire the beacons signals from different femto cells at different times. This function-based scheme is applicable to more than 2 femto cells (e.g., using phase offsets of 120 degrees, or 90 degrees, and so on). In addition, an amplitude formula scheme may be used with other types of functions (e.g., triangle waves, square waves, or more complicated functions).

The operations of FIG. 2 relate to configuring femto cells to transmit beacon signals in a specified manner for access terminal location estimation. Thus, in some cases, a femto cell may be instructed to transmit beacon signals in a different manner during a location estimation procedure than it does for normal mobility operations.

As represented by block 202, at some point in time, an entity in the network determines one or more parameters for beacon signal transmission, where the parameter(s) is(are) to be used in conjunction with the estimation of one or more locations of an access terminal. One such parameter is beacon signal transmission timing for a plurality of femto cells. As discussed above, for a given femto cell, these parameters may indicate whether the femto cell is to transmit beacon signals, when the femto cell is to transmit beacon signals, the frequency on which the beacon signals are to be transmitted, any function that is to be used for the transmission, and so on.

The operations of block 202 may be performed relatively infrequently or relatively frequently. As an example of the former case, the parameter(s) may be determined upon installation or reconfiguration of the femto cells.

As an example of the latter case, the parameter(s) may be determined whenever an entity in the network determines that a location estimate is needed. For example, a client in the access terminal may trigger a measurement, a serving femto cell may request the access terminal to report signal strength measurements from all the visible femto cells, or some other entity may initiate such a request. In conjunction with these operations, the parameter(s) to be used to transmit beacon signals during the location estimation procedure may be determined.

As represented by block 204, as a result of the determination of block 202, at least one message is sent to control the transmission of beacon signals at the femto cells. For example, a single message that specifies all of the parameters to be used by the different femto cells may be broadcast to all of the femto cells. As another example, a dedicated message may be sent to each femto cell, whereby that message only specifies the parameter(s) to be used by that femto cell.

The operations of blocks 202 and 204 may be performed by various entities. In some embodiments, these operations are performed by a network entity (e.g., a femto management server, etc.). In some embodiments, these operations are performed by one of the femto cells (e.g., the serving femto cell for the access terminal). In this latter case, the femto cell sends the message(s) to the other femto cells via a network entity or some other suitable path. Also, in this case, the femto cell will maintain the beacon signal timing information that is it to use for beacon signal transmissions.

Blocks 206 and 208 describe operations that may be performed at one of the femto cells. As represented by block 206, a message requesting transmission of beacon signals is received at a femto cell. As discussed above, this message indicates beacon signal transmission timing for a plurality of femto cells for access terminal location estimation.

As represented by block 208, the femto cell transmits beacon signals in a manner based on the received message. For example, the femto cell may refrain from transmitting beacon signals for a period of time (or until instructed to do so). The femto cell may transmit beacon signals at designated times and/or on a designated frequency. The femto cell may use a designated amplitude formula function to transmit beacon signals.

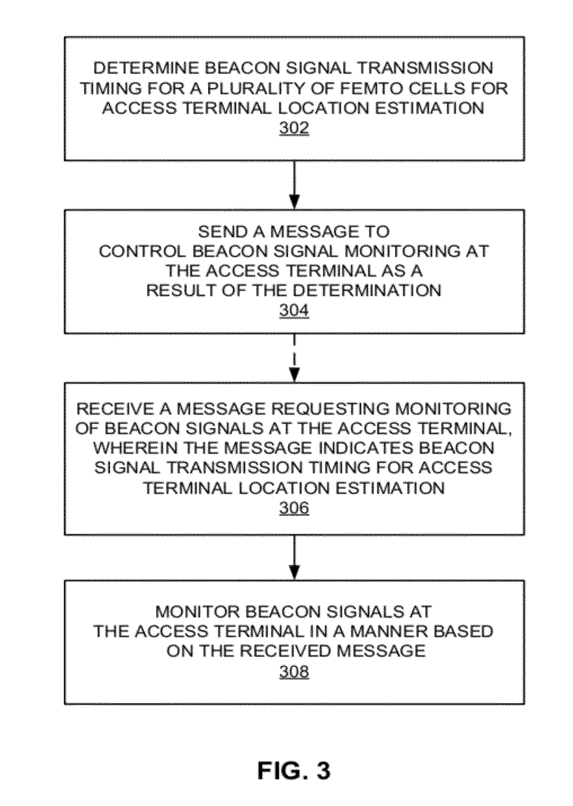

The operations of FIG. 3 relate to configuring an access terminal to monitor for beacon signals in a specified manner for access terminal location estimation. Thus, in some cases, an access terminal may be instructed to monitor for beacon signals in a different manner during a location estimation procedure than it does for normal mobility operations.

Block 302 of FIG. 3 corresponds to block 202 of FIG. 2. Thus, beacon signal transmission timing for a plurality of femto cells is defined for access terminal location estimation, along with other parameters in some cases.

As represented by block 304, as a result of the determination of block 302, a message is sent to control the monitoring of beacon signals at the access terminal. In some aspects, the message indicates the beacon signal (e.g., a scrambling code, a PN offset, or a physical cell ID) to be monitored. In some aspects, the message indicates beacon signal transmission timing (e.g., a periodicity at which the access terminal is to monitor for beacon signals). Here, by sending the access terminal comparable (e.g., the same) parameters that were sent to the femto cells, the access terminal will be able to monitor for beacon signals at the correct times, on the correct frequencies, from the correct femto cells, etc., based on the timing information, frequency information, femto cell identifiers (e.g., pseudorandom number (PN) codes), and so on included in the received message.

The operations of blocks 302 and 304 may be performed by various entities as discussed above. For example, in various embodiments, these operations may be performed by a network entity, one of the femto cells, or some other suitable entity.

Blocks 306 and 308 describe operations that may be performed at the access terminal. As represented by block 306, a message requesting monitoring of beacon signals is received at the access terminal. As discussed above, this message indicates beacon signal transmission timing for a plurality of femto cells for access terminal location estimation.

As represented by block 308, the access terminal monitors for beacon signals in a manner based on the received message. For example, the access terminal may only monitor for beacon signals from specified femto cells. In addition, the femto cell may monitor for beacon signals at designated times and/or on a designated frequency.

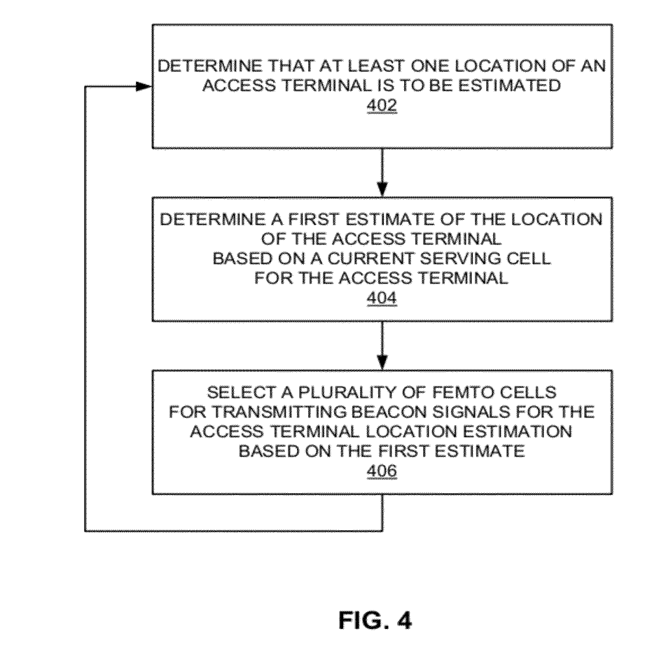

FIG. 4 describes sample operations that may be performed to select which femto cells are to transmit beacon signals. In particular, this selection is based on a preliminary estimate of the location of the femto cell.

In this way, the number of femto cells that transmit beacon signals may be restricted to limit interference that may otherwise be caused by the transmission of beacon signals by a set of femto cells (e.g., where the set includes all of the femto cells associated with a particular enterprise). For example, only those femto cells of the set that are relatively close to the access terminal may be selected to transmit beacon signals. Consequently, other femto cells of the set will not transmit beacon signals unless the access terminal moves closer to them. This could be triggered, for example, by the femto cells being added in the active set of the access terminal.

Referring to the operations of FIG. 4, as represented by block 402, at some point in time, it is determined that at least one location of an access terminal is to be estimated. As discussed above, this determination (as well as the operations of blocks 404 and 404) may be made by the access terminal, a serving femto cell, a network entity, or some other entity.

As represented by block 404, a first estimate of the location of the access terminal is determined. For example, this estimate may be based on the current serving cell for the access terminal. That is, since the access terminal will be within a certain distance of the serving cell, a rough estimate of the location of the access terminal may be obtained here.

As represented by block 406, a plurality of femto cells that will transmit beacon signals for the access terminal location estimation procedure are selected based on the first estimate determined at block 404. For example, all of the femto cells within a defined distance from the serving cell may be selected here. As another example, neighboring femto cells (e.g., immediate neighbors) of the serving cell may be selected here. As yet another example, the selection of the femto cells may be triggered by the femto cells being added in the active set of the access terminal.

As represented by the arrow from block 406 to 402, these operations may be repeated whenever a location estimate is needed. Thus, in the event the access terminal moves within the coverage of the set of femto cells, different femto cells of the set will be selected depending on the current location of the access terminal (e.g., depending on which femto cell is currently serving the access terminal).

Referring to FIG. 5, as mentioned above, one or more active set parameters may be adjusted in an attempt to increase the number of femto cells that an access terminal “hears” during a location estimation procedure for the access terminal. Thus, an access terminal may use a different active set during a location estimation procedure than it does for normal mobility operations.

For example, prior to commencing a location estimate procedure that relies on downlink pilots (e.g., for path loss-based or timing-based triangulation), it may be desirable to increase the size of the active set for the access terminal so that the access terminal will measure signals from additional femto cells, thereby improving the accuracy of the estimation procedure. Here, the PSMM (or some other type measurement report) contains the measurement from all pilots in the active set. Thus, for location estimation, T_ADD and T_DROP, which are parameters specified by the femto cell and used for active set management, may be set to relatively low values to ensure that more (e.g., most or all) of the femto cells in the vicinity are added to the active set and to ensure that these femto cells do not get dropped once they are added. Moreover, the femto cell can also ignore dropping a pilot that is below T_DROP from the active set if such pilot is still useful for location estimation purposes.

Referring to the operations of FIG. 5, as represented by block 502, at some point in time, it is determined that at least one location of an access terminal is to be estimated. As discussed above, this determination may be made by the access terminal, a serving femto cell, a network entity, or some other entity.

As represented by block 504, as a result of the determination of block 502, a message is sent to adjust at least one active set parameter for the access terminal. This operation (as well as the operations of blocks 506 and 508) may be made by a serving femto cell, a network entity, or some other entity. For example, the serving femto cell may send a message to the access terminal to inform the access terminal of this change. As another example, a network entity may send a message to the serving femto cell to instruct the serving femto cell to make this change.

As represented by blocks 506 and 508, the location estimation-specific active set parameters are maintained during the location estimation procedure. Then, once the location estimation procedure is complete (block 506), a message is sent (e.g., in a similar manner as discussed above), to restore each active set parameter to its prior value.

Referring to FIG. 6, as mentioned above, in implementations that rely on downlink signals (e.g., as opposed to beacon signals), it may be desirable to mitigate (e.g., reduce or eliminate) interference from another femto cell. For example, the serving femto cell for an access terminal may stop or reduce transmit power on some or all of its forward link channels (e.g., pilot, paging, traffic), in conjunction with requesting the access terminal to perform measurements. This will help to reduce the dominating interference generated from the serving femto cell on other pilot signals and enable all the access terminals being served by the femto cell to get accurate measurements from the non-serving femto cells. Preferably, steps will be taken here to ensure that this operation does not adversely affect users on the serving femto cell (e.g., there are no pages to deliver during that time or the stop duration does not cause call drop).

Referring to the operations of FIG. 6, as represented by block 602, it is determined that at least one location of an access terminal is to be estimated (e.g., as discussed above). As represented by block 604, as a result of the determination of block 602, a femto cell (e.g., a serving femto cell) that interferes with reception of signals at the access terminal is identified. As represented by block 606, a message is sent to temporarily limit transmission by the femto cell identified at block 604. For example, a femto management server may send a request to the femto cell requesting that the femto cell do one or more of: reduce transmit power, disable transmission, or use a lower transmission rate. As represented by block 608, a message is also sent to the access terminal to instruct the access terminal to monitor for signals while the transmissions by the femto cell are limited. In some implementations, this message specifies at least one timing parameter for the monitoring (e.g., a period or length of time to conduct the monitoring).

In general, the location estimation techniques describe above rely on obtaining a fingerprint of the access terminal and matching it against a database. It may be desirable to increase the number of entries in the fingerprint database as the more entries that exist, the better the triangulation. The variation of these entries in space also is a factor because path loss typically has a high gradient in indoor environments. The variability in these entries at the same point over time and measurement error is also important as the path loss at a point from a femto cell is not a single value but a distribution due to channel fading and multipath. Since the database may be fixed, for a fixed location in space, the predicted point will change with time. Errors in measurement will also cause these errors. To overcome some of these shortcomings and improve the system, one or more of the techniques that follow may be employed.

In some implementations, a combination of the above-described approaches for location measurement may be employed to combat fading.

In some implementations, a database of macro path loss is generated. In this case, CFS may be used to obtain macro path loss measurements that may be used as additional degrees in the fingerprint. It should be noted that mapping macro path loss may be difficult as it uses knowledge of macro cell locations and, in general, careful measurements all around the required area. The total interference on the macro or femto channels can also be used for the same purpose, although the gradient in these quantities may not be as strong as path loss.

In some implementations, architectural maps of the building and other higher level contextual information can be used to improve the system. The information can be used to develop probabilistic models of motion which can be used in particle filters. A Markov model may be developed to model the access terminal's movement as a finite state space. These methods may lead to high improvement as indoor motion in a given space is largely predictable based on the importance of different areas in a building and physical limitations of walls.

In some implementations, a beamforming beacon transmitter may be used to help extract more out of the each femto cell measurement. With an omnidirectional antenna, only path loss can be measured which in some sense locates the access terminal in a circle around the femto cell. In contrast, with a beamforming transmitter, the specific direction of the user can also be disambiguated and thus location estimation is better.

In some navigation-related implementations, the system may use information from past and current measurements, as well as past and current predicted positions of the user. Apart from this, the system will try to take advantage of the layout and floor plan of the building itself It will use the floor plan and other meta information to predict the most likely next position of the user as it would know the set of possible points as limited by physical restraints (going through a wall) and by popularity of the place (learnt through crowd sourcing or from the plan itself). If the system is helping navigate the user from point A to B, it knows the path it has recommended and thus locating and guiding the user along the path will be much easier.

With the above in mind, sample operations for estimating a location of an access terminal based on signals received by the access terminal will be described in more detail. When a location estimate is needed, an entity of the network may trigger a measurement at an access terminal. For example, as discussed above a client in the access terminal may trigger a measurement or the serving femto cell may request the access terminal to report signal strength measurements. If the client is in the access terminal, the access terminal will generally have application layer protocols to communicate with a server to exchange information needed by or provided by the location estimation procedure (e.g., measurement information, map information, location estimate).

To perform the measurement, the access terminal is assumed to be in an active call. If the access terminal is not active, a dummy call can be initiated. The specific procedures for reporting the pilots and beacons are slightly different for cdma2000 1× and UMTS. In UMTS, the serving femto cell requests the access terminal to send a measurement report message (MRM) which contains Ecp/Io and Ecp information for measured pilots. A similar procedure may be used to request measurement of beacon signals on other frequencies.

In cdma2000, the serving femto cell requests the access terminal to send a PSMM (Pilot Strength Measurement Message), either once or periodically. As part of the PSMM report, the access terminal sends the Ecp/Io of all femto cells which are measurable and the total Io, where Ecp is the received signal strength of the femto cell pilot and Io is the total received energy on the serving femto cell frequency (as measured by the access terminal). The path loss to each visible femto cell can then be calculated using the femto cell transmit powers. A similar procedure, CFS is used to report beacon signal strengths measured on the macro frequencies.

For purposes of further explanation, three examples of processes for acquiring received signal information and using that information to estimate the location of an access terminal follow. The first example employs path loss information derived from the signal strength of downlink signals. The second example employs path loss information derived from the signal strength of beacon signals. The third example employs timing information derived from the timing of downlink signals.

Signal strength-based triangulation methods rely on the relationship between the distance and the path loss of the signal from a femto cell to the access terminal to estimate the distance. While such a relationship can be described via mathematical models accurately in outdoor settings, the presence of various obstructions in indoor environment (furniture, walls, etc.) makes it difficult to have an accurate mathematical model. To address this issue, a database of path loss values at each of a set of locations is developed. This database may be generated, for example, via ray-tracing simulation of detailed building interiors using a software tool (e.g., WinProp). The path loss values associated with the current location of an access terminal can then be matched against the database to estimate the location of the access terminal.

In an embodiment that is based on received signal strength of downlink signals (e.g., in a CDMA 1× implementation), the access terminal reports the Ecp/Io of all PNs in its active set and the total Io on the channel. In one aspect of the disclosed approach, the access terminal sends the information as part of a Pilot Strength Measurement Message (PSMM). In one aspect of the disclosed approach, the serving femto cell requests the access terminal for the PSMM. The serving femto cell can also request the access terminal to send PSMM periodically while location estimation is needed. The Ecp/Io information is used to find the fingerprint of the access terminal, which in one aspect of the disclosure is the path loss from its location to all the reported femto cells. This fingerprint is matched against a database which contains the path loss values from all the points in the network's coverage region to all the femto cells. Based on these values, the point with the maximum likelihood of having the reported fingerprint is predicted. For any PSMM report, the observed path loss values will be {PL_{f1}, PL_{f2}, PL_{f3} . . . }. The set of points that maximize a likelihood function based on these path loss values is then determined and used to estimate a location of the access terminal.

In an embodiment that is based on received signal strength of beacon signals (e.g., in a CDMA 1× implementation), the serving femto cell requests the access terminal for a Candidate Frequency Search (CFS) report and specifies the list of beacon PNs to be searched. This list may be limited as only a few PNs will typically be reserved for beacon signal transmission on the other carrier. As above, the access terminal is in an active call here. The access terminal sends the CFS report, which contains the Ecp/Io of the requested PNs and the total Io on the macro channel. The report is used to determine the path loss to femto cells and use it as a fingerprint. The fingerprint is then used in conjunction with an appropriate database to determine the location of the access terminal (e.g., based on a probability model as discussed above).

In time-based triangulation methods, the signal propagation delay for communication between two points can be used to estimate the distance between them. For example, in time-of-arrival-based triangulation, the access terminal measures the time delay from its location to a group of femto cells. The access terminal may obtain these time delay values using the time of arrival of the earliest peak from each femto cell that it can decode. Since the access terminal is synchronized with its serving cell, all timing measurements will be offset by the time delay to the serving cell. This fingerprint (time difference between a group of reported cells and the serving cell) can thus be matched against a database of such values to estimate the current location of the access terminal.

The accuracy of this method depends, for example, on the number of femto cells to which time delay can be measured and the resolution at which the time can be reported. In some cases, the measurement resolution is typically at chip/16 granularity. The accuracy of the observed timing may be improved using the following technique. A femto cell gradually adjusts its reference pilot timing with increment of 1/x chip and observes when the estimated delay increases by 1/16 chip. If this happens after y increments, the true time delay is increased by approximately (1−y/x)/16 chips more than originally estimated.

Through the use of the location estimation techniques taught herein, an access terminal user may advantageously be able to use a variety of location-based services even in an indoor environment. For example, a user may be able to locate himself/herself indoors on a map and navigate to desired areas. A user may be able to locate himself/herself and friends in public places, find the path to their point of interest, and receive information on services in their immediate vicinity. Enterprises that deploy femto cells may be able to track their resources and staff and efficiently manage their workforce.

FIG. 7 illustrates several sample components (represented by corresponding blocks) that may be incorporated into nodes such as an access terminal 702, an access point 704, and a network entity 706 (e.g., corresponding to the access terminal 102, the access point 104, and the network entity 110, respectively, of FIG. 1) to perform transmit power control-related operations as taught herein. The described components also may be incorporated into other nodes in a communication system. For example, other nodes in a system may include components similar to those described for one or more of the access terminal 702, the access point 704, or the network entity 706 to provide similar functionality. Also, a given node may contain one or more of the described components. For example, an access point may contain multiple transceiver components that enable the access point to operate on multiple carriers and/or communicate via different technologies.

As shown in FIG. 7, the access terminal 702 and the access point 704 each include one or more wireless transceivers (as represented by a transceiver 708 and a transceiver 710, respectively) for communicating with other nodes. Each transceiver 708 includes a transmitter 712 for sending signals (e.g., messages, measurement reports, indications, other types of information, and so on) and a receiver 714 for receiving signals (e.g., messages, FL signals, pilot signals, beacon signals, location estimation-related parameters, other types of information, and so on). Similarly, each transceiver 710 includes a transmitter 716 for sending signals (e.g., messages, requests, indications, FL signals, pilot signals, beacon signals, location estimation-related parameters, other types of information, and so on) and a receiver 718 for receiving signals (e.g., messages, measurement reports, other types of information, and so on).

The access point 704 and the network entity 706 each include one or more network interfaces (as represented by a network interface 720 and a network interface 722, respectively) for communicating with other nodes (e.g., other network entities). For example, the network interfaces 720 and 722 may be configured to communicate with one or more network entities via a wire-based or wireless backhaul or backbone. In some aspects, the network interfaces 720 and 722 may be implemented as a transceiver (e.g., including transmitter and receiver components) configured to support wire-based or wireless communication (e.g., sending and receiving: messages, measurement reports, indications, location estimation-related parameters, other types of information, and so on). Accordingly, in the example of FIG. 7, the network interface 720 is shown as comprising a transmitter 724 for sending signals and a receiver 726 for receiving signals. Similarly, the network interface 722 is shown as comprising a transmitter 728 for sending signals and a receiver 730 for receiving signals.

The access terminal 702, the access point 704, and the network entity 706 also include other components that may be used to support power control-related operations as taught herein. For example, the access terminal 702 includes a processing system 732 for providing functionality relating to location estimation (e.g., determine that the location of the access terminal is to be estimated) and for providing other processing functionality. Similarly, the access point 704 includes a processing system 734 for providing functionality relating to location estimation (e.g., determine beacon signal transmission timing, determine that at least one location of an access terminal is to be estimated, determine a first estimate of the location of the access terminal, select a plurality of femto cells based on the first estimate, identify a first femto cell that interferes with reception of signals at the access terminal) and for providing other processing functionality. Also, the network entity 706 includes a processing system 736 for providing functionality relating to location estimation (e.g., as described above for the processing system 734) and for providing other processing functionality. The access terminal 702, the access point 704, and the network entity 706 include memory components 738, 740, and 742 (e.g., each including a memory device), respectively, for maintaining information (e.g., fingerprint values, measurement report information, thresholds, parameters, and so on). In addition, the access terminal 702, the access point 704, and the network entity 706 include user interface devices 742, 744, and 746, respectively, for providing indications (e.g., audible and/or visual indications) to a user and/or for receiving user input (e.g., upon user actuation of a sensing device such a keypad, a touch screen, a microphone, and so on).

For convenience the access terminal 702 and the access point 704 are shown in FIG. 7 as including components that may be used in the various examples described herein. In practice, the illustrated blocks may have different functionality in different implementations. For example, the processing systems 732, 734, and 736 will be configured to support different operations in implementations that employ different wireless communication technologies.

The components of FIG. 7 may be implemented in various ways. In some implementations the components of FIG. 7 may be implemented in one or more circuits such as, for example, one or more processors and/or one or more ASICs (which may include one or more processors). Here, each circuit (e.g., processor) may use and/or incorporate data memory for storing information or executable code used by the circuit to provide this functionality. For example, some of the functionality represented by block 708 and some or all of the functionality represented by blocks 732, 738, and 742 may be implemented by a processor or processors of an access terminal and data memory of the access terminal (e.g., by execution of appropriate code and/or by appropriate configuration of processor components). Similarly, some of the functionality represented by block 710 and some or all of the functionality represented by blocks 720, 734, 740, and 744 may be implemented by a processor or processors of an access point and data memory of the access point (e.g., by execution of appropriate code and/or by appropriate configuration of processor components). Also, some or all of the functionality represented by blocks 722, 736, 742, and 746 may be implemented by a processor or processors of a network entity and data memory of the network entity (e.g., by execution of appropriate code and/or by appropriate configuration of processor components).

As discussed above, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNodeB, macro cell, and so on. Also, a femto access point may be configured or referred to as a Home NodeB, Home eNodeB, access point base station, femto cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

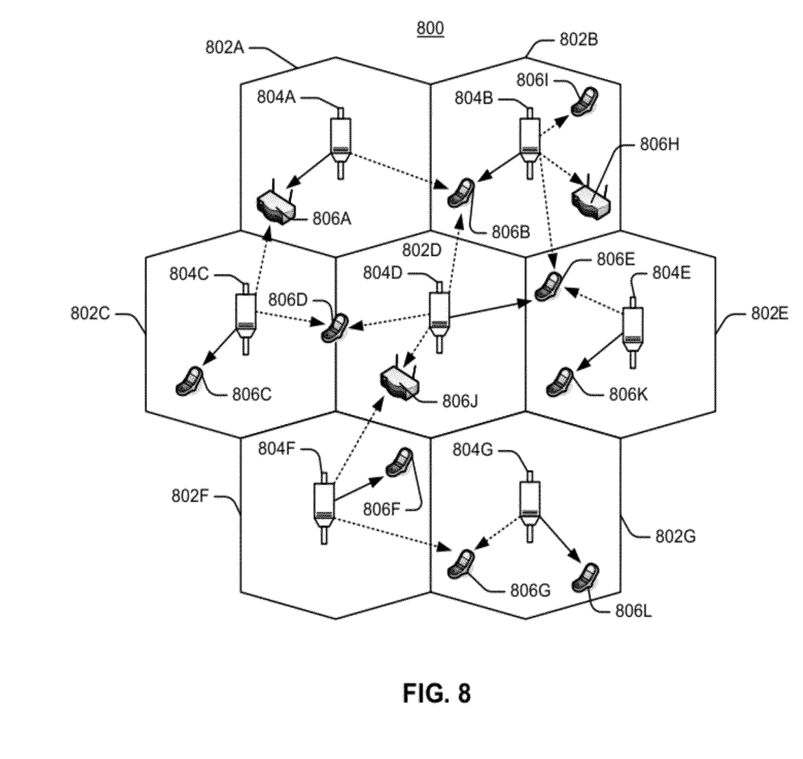

FIG. 8 illustrates a wireless communication system 800, configured to support a number of users, in which the teachings herein may be implemented. The system 800 provides communication for multiple cells 802, such as, for example, macro cells 802A-802G, with each cell being serviced by a corresponding access point 804 (e.g., access points 804A-804G). As shown in FIG. 8, access terminals 806 (e.g., access terminals 806A-806L) may be dispersed at various locations throughout the system over time. Each access terminal 806 may communicate with one or more access points 804 on a forward link (FL) and/or a reverse link (RL) at a given moment, depending upon whether the access terminal 806 is active and whether it is in soft handoff, for example. The wireless communication system 800 may provide service over a large geographic region. For example, macro cells 802A-802G may cover a few blocks in a neighborhood or several miles in a rural environment.

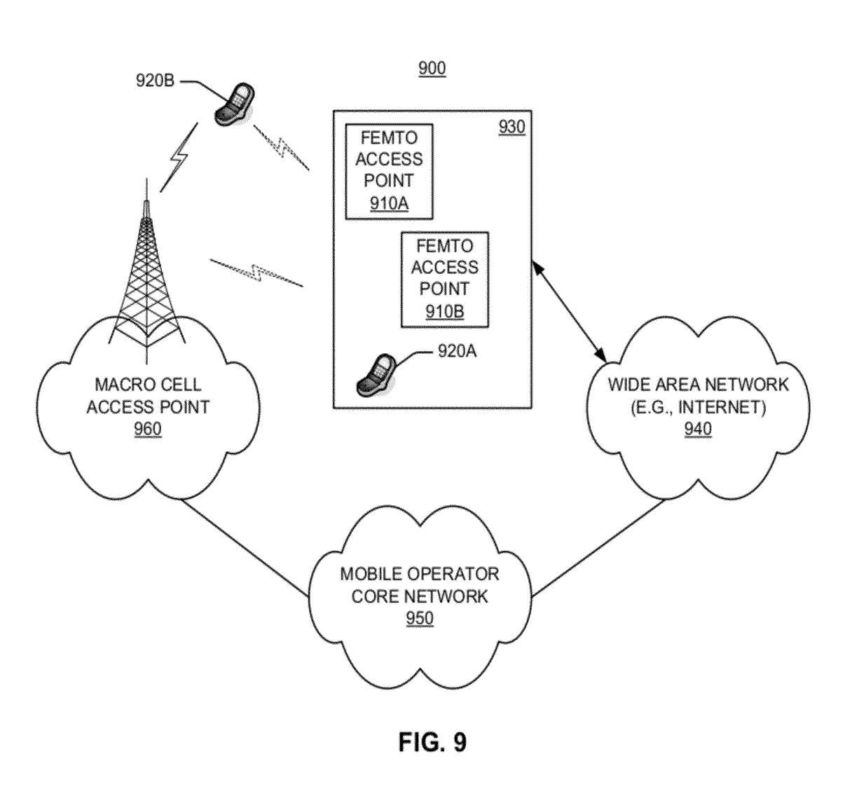

FIG. 9 illustrates an exemplary communication system 900 where one or more femto access points are deployed within a network environment. Specifically, the system 900 includes multiple femto access points 910 (e.g., femto access points 910A and 910B) installed in a relatively small scale network environment (e.g., in one or more user residences 930). Each femto access point 910 may be coupled to a wide area network 940 (e.g., the Internet) and a mobile operator core network 950 via a DSL router, a cable modem, a wireless link, or other connectivity means (not shown). As will be discussed below, each femto access point 910 may be configured to serve associated access terminals 920 (e.g., access terminal 920A) and, optionally, other (e.g., hybrid or alien) access terminals 920 (e.g., access terminal 920B). In other words, access to femto access points 910 may be restricted whereby a given access terminal 920 may be served by a set of designated (e.g., home) femto access point(s) 910 but may not be served by any non-designated femto access points 910 (e.g., a neighbor's femto access point 910).

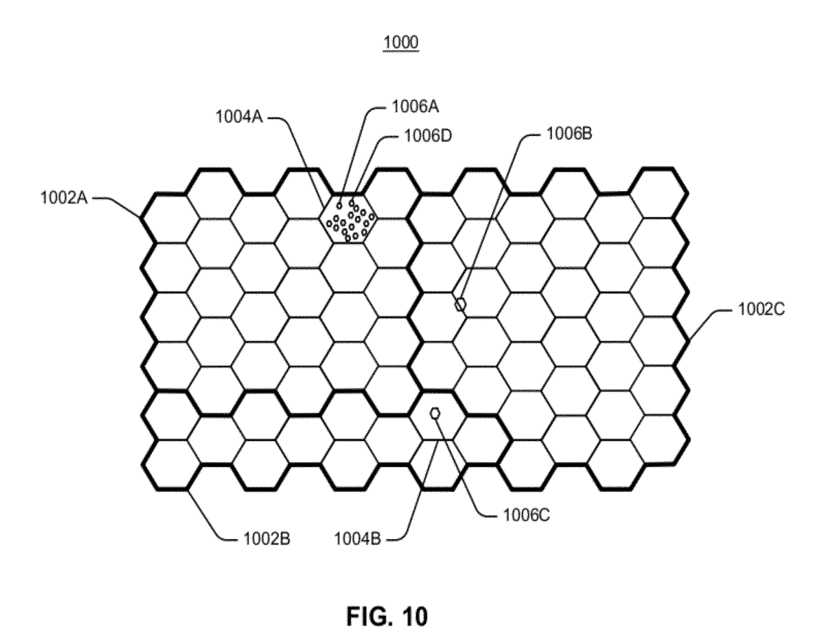

FIG. 10 illustrates an example of a coverage map 1000 where several tracking areas 1002 (or routing areas or location areas) are defined, each of which includes several macro coverage areas 1004. Here, areas of coverage associated with tracking areas 1002A, 1002B, and 1002C are delineated by the wide lines and the macro coverage areas 1004 are represented by the larger hexagons. The tracking areas 1002 also include femto coverage areas 1006. In this example, each of the femto coverage areas 1006 (e.g., femto coverage areas 1006B and 1006C) is depicted within one or more macro coverage areas 1004 (e.g., macro coverage areas 1004A and 1004B). It should be appreciated, however, that some or all of a femto coverage area 1006 may not lie within a macro coverage area 1004. In practice, a large number of femto coverage areas 1006 (e.g., femto coverage areas 1006A and 1006D) may be defined within a given tracking area 1002 or macro coverage area 1004. Also, one or more pico coverage areas (not shown) may be defined within a given tracking area 1002 or macro coverage area 1004.

Referring again to FIG. 9, the owner of a femto access point 910 may subscribe to mobile service, such as, for example, 3G mobile service, offered through the mobile operator core network 950. In addition, an access terminal 920 may be capable of operating both in macro environments and in smaller scale (e.g., residential) network environments. In other words, depending on the current location of the access terminal 920, the access terminal 920 may be served by a macro cell access point 960 associated with the mobile operator core network 950 or by any one of a set of femto access points 910 (e.g., the femto access points 910A and 910B that reside within a corresponding user residence 930). For example, when a subscriber is outside his home, he is served by a standard macro access point (e.g., access point 960) and when the subscriber is at home, he is served by a femto access point (e.g., access point 910A). Here, a femto access point 910 may be backward compatible with legacy access terminals 920.

A femto access point 910 may be deployed on a single frequency or, in the alternative, on multiple frequencies. Depending on the particular configuration, the single frequency or one or more of the multiple frequencies may overlap with one or more frequencies used by a macro access point (e.g., access point 960).

In some aspects, an access terminal 920 may be configured to connect to a preferred femto access point (e.g., the home femto access point of the access terminal 920) whenever such connectivity is possible. For example, whenever the access terminal 920A is within the user's residence 930, it may be desired that the access terminal 920A communicate only with the home femto access point 910A or 910B.

In some aspects, if the access terminal 920 operates within the macro cellular network 950 but is not residing on its most preferred network (e.g., as defined in a preferred roaming list), the access terminal 920 may continue to search for the most preferred network (e.g., the preferred femto access point 910) using a better system reselection (BSR) procedure, which may involve a periodic scanning of available systems to determine whether better systems are currently available and subsequently acquire such preferred systems. The access terminal 920 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 910, the access terminal 920 selects the femto access point 910 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macro cell mobile network and a defined set of femto access points (e.g., the femto access points 910 that reside within the corresponding user residence 930). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e.g., limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T},N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

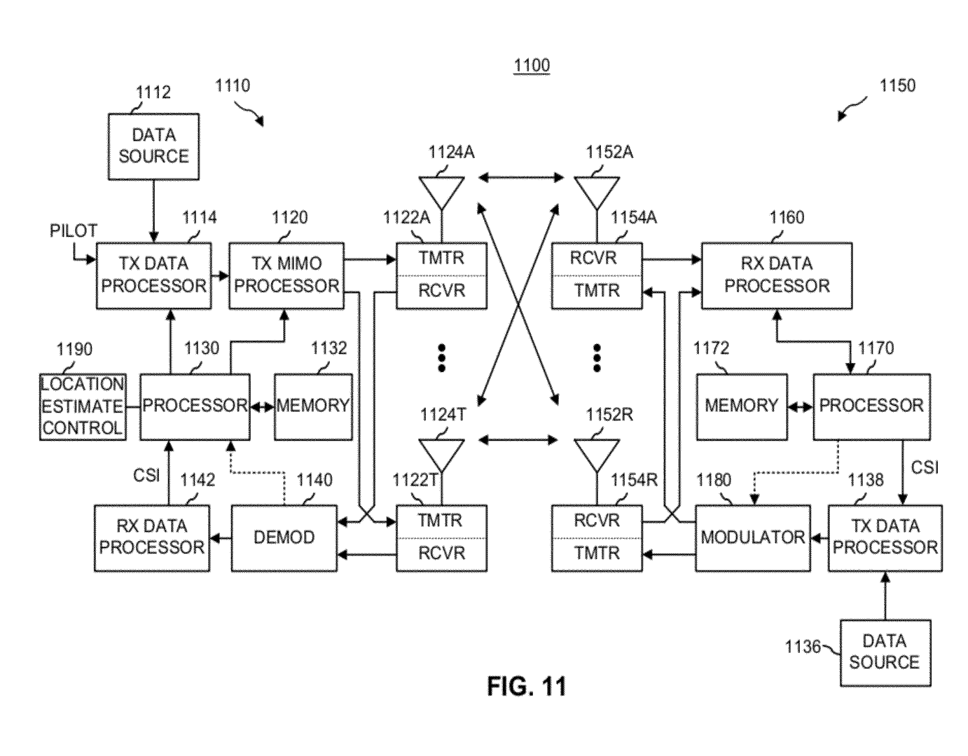

FIG. 11 illustrates a wireless device 1110 (e.g., an access point) and a wireless device 1150 (e.g., an access terminal) of a sample MIMO system 1100. At the device 1110, traffic data for a number of data streams is provided from a data source 1112 to a transmit (TX) data processor 1114. Each data stream may then be transmitted over a respective transmit antenna.

The TX data processor 1114 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1130. A data memory 1132 may store program code, data, and other information used by the processor 1130 or other components of the device 1110.

The modulation symbols for all data streams are then provided to a TX MIMO processor 1120, which may further process the modulation symbols (e.g., for OFDM). The TX MIMO processor 1120 then provides N_{T} modulation symbol streams to N_{T} transceivers (XCVR) 1122A through 1122T. In some aspects, the TX MIMO processor 1120 applies beam-forming weights to the symbols of the data streams and to the antenna from which the symbol is being transmitted.

Each transceiver 1122 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1122A through 1122T are then transmitted from N_{T} antennas 1124A through 1124T, respectively.

At the device 1150, the transmitted modulated signals are received by N_{R} antennas 1152A through 1152R and the received signal from each antenna 1152 is provided to a respective transceiver (XCVR) 1154A through 1154R. Each transceiver 1154 conditions (e.g., filters, amplifies, and downconverts) a respective received signal, digitizes the conditioned signal to provide samples, and further processes the samples to provide a corresponding “received” symbol stream.

A receive (RX) data processor 1160 then receives and processes the N_{R} received symbol streams from N_{R} transceivers 1154 based on a particular receiver processing technique to provide N_{T} “detected” symbol streams. The RX data processor 1160 then demodulates, deinterleaves, and decodes each detected symbol stream to recover the traffic data for the data stream. The processing by the RX data processor 1160 is complementary to that performed by the TX MIMO processor 1120 and the TX data processor 1114 at the device 1110.

A processor 1170 periodically determines which pre-coding matrix to use (discussed below). The processor 1170 formulates a reverse link message comprising a matrix index portion and a rank value portion. A data memory 1172 may store program code, data, and other information used by the processor 1170 or other components of the device 1150.

The reverse link message may comprise various types of information regarding the communication link and/or the received data stream. The reverse link message is then processed by a TX data processor 1138, which also receives traffic data for a number of data streams from a data source 1136, modulated by a modulator 1180, conditioned by the transceivers 1154A through 1154R, and transmitted back to the device 1110.

At the device 1110, the modulated signals from the device 1150 are received by the antennas 1124, conditioned by the transceivers 1122, demodulated by a demodulator (DEMOD) 1140, and processed by a RX data processor 1142 to extract the reverse link message transmitted by the device 1150. The processor 1130 then determines which pre-coding matrix to use for determining the beam-forming weights then processes the extracted message.

FIG. 11 also illustrates that the communication components may include one or more components that perform location estimation control operations as taught herein. For example, a location estimate control component 1190 may cooperate with the processor 1130 and/or other components of the device 1110 to estimate the location of another device (e.g., device 1150) as taught herein. It should be appreciated that for each device 1110 and 1150 the functionality of two or more of the described components may be provided by a single component. For example, a single processing component may provide the functionality of the location estimate control component 1190 and the processor 1130.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

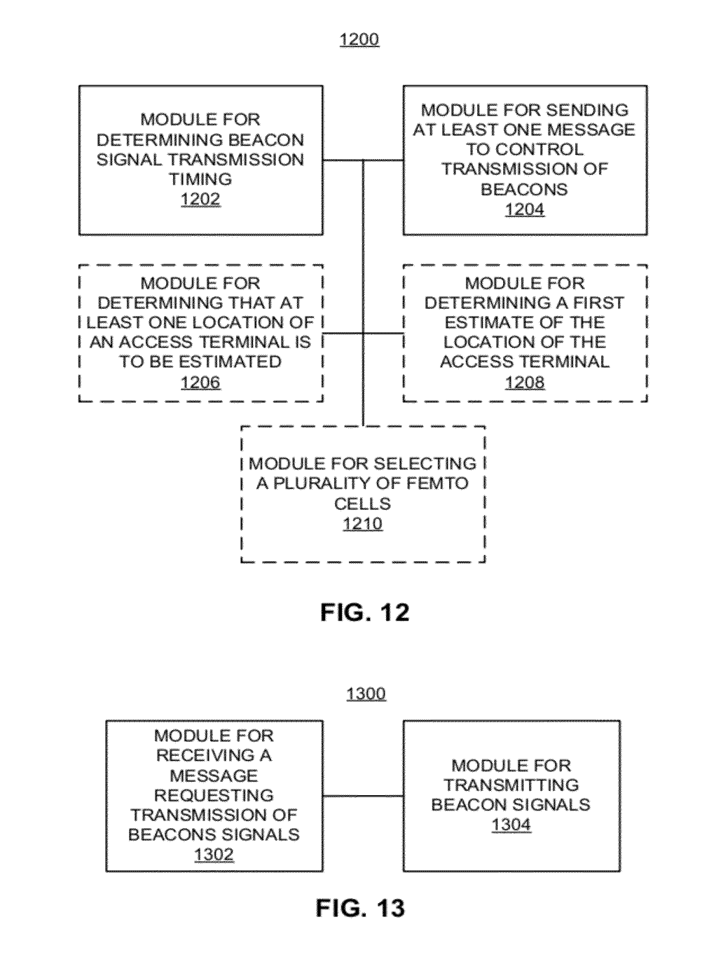

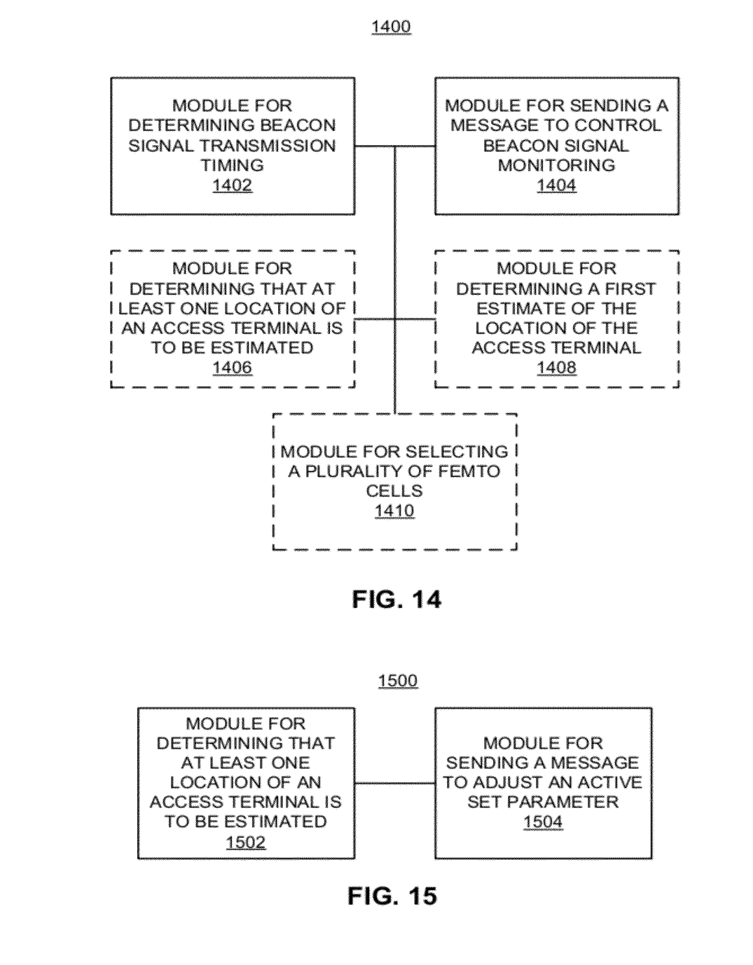

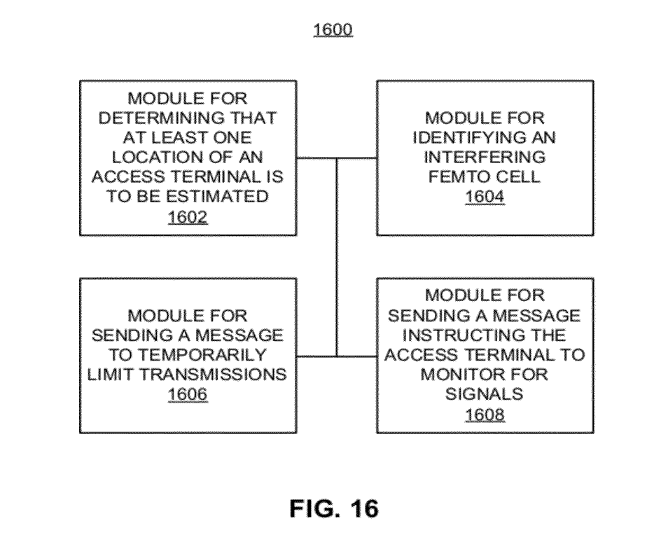

The functionality described herein (e.g., with regard to one or more of the accompanying figures) may correspond in some aspects to similarly designated “means for” functionality in the appended claims. Referring to FIGS. 12-16, apparatuses 1200, 1300, 1400, 1500, and 1600 are represented as a series of interrelated functional modules. Here, a module for determining beacon signal transmission timing 1202 may correspond at least in some aspects to, for example, a processing system as discussed herein. A module for sending at least one message to control transmission of beacon signals 1204 may correspond at least in some aspects to, for example, a transmitter as discussed herein. A module for determining that at least one location of an access terminal is to be estimated 1206 may correspond at least in some aspects to, for example, a processing system as discussed herein. A module for determining a first estimate of the location of the access terminal 1208 may correspond at least in some aspects to, for example, a processing system as discussed herein. A module for selecting a plurality of femto cells 1210 may correspond at least in some aspects to, for example, a processing system as discussed herein. A module for receiving a message requesting transmission of beacon signals 1302 may correspond at least in some aspects to, for example, a receiver as discussed herein. A module for transmitting beacon signals 1304 may correspond at least in some aspects to, for example, a transmitter as discussed herein. A module for determining beacon signal transmission timing 1402 may correspond at least in some aspects to, for example, a processing system as discussed herein. A module for sending a message to control beacon signal monitoring 1404 may correspond at least in some aspects to, for example, a transmitter as discussed herein. A module for determining that at least one location of an access terminal is to be estimated 1406 may correspond at least in some aspects to, for example, a processing system as discussed herein. A module for determining a first estimate of the location of the access terminal 1408 may correspond at least in some aspects to, for example, a processing system as discussed herein. A module for selecting a plurality of femto cells 1410 may correspond at least in some aspects to, for example, a processing system as discussed herein. A module for determining that at least one location of an access terminal is to be estimated 1502 may correspond at least in some aspects to, for example, a processing system as discussed herein. A module for sending a message to adjust an active set parameter 1504 may correspond at least in some aspects to, for example, a transmitter as discussed herein. A module for determining that at least one location of an access terminal is to be estimated 1602 may correspond at least in some aspects to, for example, a processing system as discussed herein. A module for identifying an interfering femto cell 1604 may correspond at least in some aspects to, for example, a processing system as discussed herein. A module for sending a message to temporarily limit transmissions 1606 may correspond at least in some aspects to, for example, a transmitter as discussed herein. A module for sending a message instructing the access terminal to monitor for signals 1608 may correspond at least in some aspects to, for example, a transmitter as discussed herein.

The functionality of the modules of FIGS. 12-16 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. In some aspects one or more of any dashed blocks in FIGS. 12-16 are optional.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a processing system configured to determine beacon signal transmission timing for a plurality of femto cells for access terminal location estimation; and
a transmitter configured to send at least one message to control transmission of beacons signals at the plurality of femto cells as a result of the determination.

2. The apparatus of claim 1, wherein the message indicates that beacon signal transmission is to commence.

3. The apparatus of claim 1, wherein the message indicates beacon signal transmission timing.

4. The apparatus of claim 3, wherein the beacon signal transmission timing comprises a staggered beacon transmission schedule for the femto cells.

5. The apparatus of claim 1, wherein the message indicates a carrier frequency for the transmission of the beacon signals.

6. The apparatus of claim 1, wherein the message indicates a formula for determining different amplitudes at different times for beacon signal transmission.

7. The apparatus of claim 6, wherein the formula is based on a sinusoid.

8. The apparatus of claim 1, wherein the processing system is further configured to:
determine that a location of an access terminal is to be estimated;
determine a first estimate of the location of the access terminal based on a current serving femto cell for the access terminal; and
select the plurality of femto cells based on the first estimate.

9. The apparatus of claim 8, wherein the selected plurality of femto cells comprise at least one neighboring femto cell of the current serving cell for the access terminal.

10. The apparatus of claim 1, wherein the message indicates that a serving femto cell for the access terminal is to temporarily limit beacon signal transmissions.

11. The apparatus of claim 1, wherein the beacon signal transmission timing is based on a determination as to whether concurrent beacon signals transmissions by the femto cells can be measured by the access terminal.

12. A method of communication, comprising:
determining beacon signal transmission timing for a plurality of femto cells for access terminal location estimation; and
sending at least one message to control transmission of beacons signals at the plurality of femto cells as a result of the determination.

13. The method of claim 12, wherein the message indicates beacon signal transmission timing.

14. The method of claim 13, wherein the beacon signal transmission timing comprises a staggered beacon transmission schedule for the femto cells.

15. The method of claim 12, further comprising:
determining that a location of an access terminal is to be estimated;
determining a first estimate of the location of the access terminal based on a current serving femto cell for the access terminal; and
selecting the plurality of femto cells based on the first estimate.

16. An apparatus for communication, comprising:
means for determining beacon signal transmission timing for a plurality of femto cells for access terminal location estimation; and
means for sending at least one message to control transmission of beacons signals at the plurality of femto cells as a result of the determination.

17. The apparatus of claim 16, wherein the message indicates beacon signal transmission timing.

18. The apparatus of claim 17, wherein the beacon signal transmission timing comprises a staggered beacon transmission schedule for the femto cells.

19. The apparatus of claim 16, further comprising:
means for determining that a location of an access terminal is to be estimated;
means for determining a first estimate of the location of the access terminal based on a current serving femto cell for the access terminal; and
means for selecting the plurality of femto cells based on the first estimate.

20. A computer-program product, comprising:
computer-readable medium comprising code for causing a computer to:
determine beacon signal transmission timing for a plurality of femto cells for access terminal location estimation; and
send at least one message to control transmission of beacons signals at the plurality of femto cells as a result of the determination.

21. The computer-program product of claim 20, wherein the message indicates beacon signal transmission timing.

22. The computer-program product of claim 21, wherein the beacon signal transmission timing comprises a staggered beacon transmission schedule for the femto cells.

23. The computer-program product of claim 20, wherein the computer-readable medium further comprises code for causing the computer to:
determine that a location of an access terminal is to be estimated;
determine a first estimate of the location of the access terminal based on a current serving femto cell for the access terminal; and
select the plurality of femto cells based on the first estimate.

24. An apparatus for communication, comprising:
a processing system configured to receive a message requesting transmission of beacons signals, wherein the message indicates beacon signal transmission timing for access terminal location estimation; and
a transmitter configured to transmit beacon signals in a manner based on the received message.

25. The apparatus of claim 24, wherein the message indicates that beacon signal transmission is to commence.

26. The apparatus of claim 24, wherein the message indicates beacon signal transmission timing.

27. The apparatus of claim 26, wherein the beacon signal transmission timing comprises a staggered beacon transmission schedule for the femto cells.

28. The apparatus of claim 24, wherein the message indicates a carrier frequency for the transmission of the beacon signals.

29. The apparatus of claim 24, wherein the message indicates a formula for determining different amplitudes at different times for beacon signal transmission.

30. The apparatus of claim 29, wherein the formula is based on a sinusoid.

31. The apparatus of claim 24, wherein the message indicates that a serving femto cell for the access terminal is to temporarily limit beacon signal transmissions.

32. The apparatus of claim 24, wherein the beacon signal transmission timing is based on a determination as to whether concurrent beacon signals transmissions by the femto cells can be measured by the access terminal.

33. A method of communication, comprising:
receiving a message requesting transmission of beacons signals, wherein the message indicates beacon signal transmission timing for access terminal location estimation; and
transmitting beacon signals in a manner based on the received message.

34. The method of claim 33, wherein the message indicates beacon signal transmission timing.

35. The method of claim 34, wherein the beacon signal transmission timing comprises a staggered beacon transmission schedule for the femto cells.

36. The method of claim 33, wherein the message indicates that a serving femto cell for the access terminal is to temporarily limit beacon signal transmissions.

37. An apparatus for communication, comprising:
means for receiving a message requesting transmission of beacons signals, wherein the message indicates beacon signal transmission timing for access terminal location estimation; and
means for transmitting beacon signals in a manner based on the received message.

38. The apparatus of claim 37, wherein the message indicates beacon signal transmission timing.

39. The apparatus of claim 38, wherein the beacon signal transmission timing comprises a staggered beacon transmission schedule for the femto cells.

40. The apparatus of claim 37, wherein the message indicates that a serving femto cell for the access terminal is to temporarily limit beacon signal transmissions.

41. A computer-program product, comprising:
computer-readable medium comprising code for causing a computer to:
receive a message requesting transmission of beacons signals, wherein the message indicates beacon signal transmission timing for access terminal location estimation; and
transmit beacon signals in a manner based on the received message.

42. The computer-program product of claim 41, wherein the message indicates beacon signal transmission timing.

43. The computer-program product of claim 42, wherein the beacon signal transmission timing comprises a staggered beacon transmission schedule for the femto cells.

44. The computer-program product of claim 41, wherein the message indicates that a serving femto cell for the access terminal is to temporarily limit beacon signal transmissions.

45. An apparatus for communication, comprising:
a processing system configured to determine beacon signal transmission timing for a plurality of femto cells for access terminal location estimation; and
a transmitter configured to send a message to control beacon signal monitoring at an access terminal as a result of the determination.

46. The apparatus of claim 45, wherein the message indicates the beacon signal to be monitored.

47. The apparatus of claim 46, wherein the indication of the beacon signal to be monitored comprises a scrambling code, a PN offset, or a physical cell ID.

48. The apparatus of claim 45, wherein the message indicates beacon signal transmission timing.

49. The apparatus of claim 48, wherein the beacon signal transmission timing comprises a staggered beacon transmission schedule for the femto cells.

50. The apparatus of claim 45, wherein the message indicates a periodicity at which the access terminal is to monitor for beacon signals.

51. The apparatus of claim 45, wherein the message indicates a carrier frequency to be monitored for the beacon signals.

52. The apparatus of claim 45, wherein the processing system is further configured to:
determine that a location of an access terminal is to be estimated;
determine a first estimate of the location of the access terminal based on a current serving femto cell for the access terminal; and
select a plurality of femto cells based on the first estimate, wherein the message indicates that the access terminal is to monitor for beacon signals from the plurality of femto cells.

53. The apparatus of claim 52, wherein the selected plurality of femto cells comprise at least one neighboring femto cell of a current serving cell for the access terminal.

54. The apparatus of claim 45, wherein the message indicates that a serving femto cell for the access terminal is to temporarily limit beacon signal transmissions.

55. The apparatus of claim 45, wherein the beacon signal transmission timing is based on a determination as to whether concurrent beacon signals transmissions by the femto cells can be measured by the access terminal.

56. A method of communication, comprising:
determining beacon signal transmission timing for a plurality of femto cells for access terminal location estimation; and
sending a message to control beacon signal monitoring at an access terminal as a result of the determination.

57. The method of claim 56, wherein the message indicates the beacon signal to be monitored.

58. The method of claim 56, wherein the message indicates beacon signal transmission timing.

59. The method of claim 56, wherein the message indicates a periodicity at which the access terminal is to monitor for beacon signals.

60. The method of claim 56, further comprising:
determining that a location of an access terminal is to be estimated;
determining a first estimate of the location of the access terminal based on a current serving femto cell for the access terminal; and
selecting a plurality of femto cells based on the first estimate, wherein the message indicates that the access terminal is to monitor for beacon signals from the plurality of femto cells.

61. The method of claim 56, wherein the message indicates that a serving femto cell for the access terminal is to temporarily limit beacon signal transmissions.

62. An apparatus for communication, comprising:
means for determining beacon signal transmission timing for a plurality of femto cells for access terminal location estimation; and
means for sending a message to control beacon signal monitoring at an access terminal as a result of the determination.

63. The apparatus of claim 62, wherein the message indicates the beacon signal to be monitored.

64. The apparatus of claim 62, wherein the message indicates beacon signal transmission timing.

65. The apparatus of claim 62, further comprising:
means for determining that a location of an access terminal is to be estimated;
means for determining a first estimate of the location of the access terminal based on a current serving femto cell for the access terminal; and
means for selecting a plurality of femto cells based on the first estimate, wherein the message indicates that the access terminal is to monitor for beacon signals from the plurality of femto cells.

66. A computer-program product, comprising:
computer-readable medium comprising code for causing a computer to:
determine beacon signal transmission timing for a plurality of femto cells for access terminal location estimation; and
send a message to control beacon signal monitoring at an access terminal as a result of the determination.

67. The computer-program product of claim 66, wherein the message indicates the beacon signal to be monitored.

68. The computer-program product of claim 66, wherein the message indicates beacon signal transmission timing.

69. The computer-program product of claim 66, wherein the computer-readable medium further comprises code for causing the computer to:
determine that a location of an access terminal is to be estimated;
determine a first estimate of the location of the access terminal based on a current serving femto cell for the access terminal; and
select a plurality of femto cells based on the first estimate, wherein the message indicates that the access terminal is to monitor for beacon signals from the plurality of femto cells.
